(19) United States
(12) Patent Application Publication
(10) Pub. No.: US 2018/0007037 A1
(43) Pub. Date: Jan. 4, 2018

(54) TRANSACTION-SPECIFIC SHARED SECRET IN ONE-TIME PASSWORD DEVICE

(71) Applicant: Kenneth Wade Reese, Portland, OR (US)

(72) Inventor: Kenneth Wade Reese, Portland, OR (US)

(21) Appl. No.: 15/200,431

(22) Filed: Jul. 1, 2016

(51) Int. Cl. H04L 29/06; H04L 9/32

(52) U.S. Cl. CPC H04L 63/0838; H04L 63/0823; H04L 63/062; H04L 9/3297; H04L 63/0435; H04L 63/0442

(57) ABSTRACT

Embodiments are directed to generation and verification of one-time passwords. A one-time password is generated by an apparatus of an authenticating party in response to a one-time password production request. The one-time password is based on a secret value shared between the apparatus and a relying party. The shared secret value is based on a private key of the apparatus and on a public key of the relying party, and is unique to the relying party and to the production request.

### TECHNICAL FIELD

Embodiments described herein generally relate to information processing and security, more particularly, to performing authentication of a transacting party using a one-time password (OTP) technique.

### BACKGROUND

One-time password (OTP) is an access credential that is valid for only a single use, such as a transaction or login session. OTP solutions are used throughout the industry to provide an additional factor to authentication protocols to assist in providing assurances that the authenticating party is legitimate and is the individual to whom authorizations should be issued based on a successful authentication. Unlike a traditional multiple-use password, an OTP provides enhanced security by preventing replay-type attacks. Therefore, even if an eavesdropper manages to capture a previous presentation of an OTP, the captured OTP will not be usable as a valid access credential.

Conventional OTP systems rely on a symmetric key-based approach in which each relying party registers or distributes OTP devices to their clients, with each relying party having knowledge of the specific symmetric key being used, or for a collection of relying parties to integrate with a central authority who possesses the symmetric key associated with a given OTP device. Thus, a shared secret needs to be exchanged between each relying party (or central authority) and each client (also referred to as an authenticating party). Also, both parties needs to keep the shared secret protected.

In addition, conventional OTP techniques have challenges relating to deployment scalability. For instance, in cases where an authenticating party has accounts with multiple various relying parties, as commonly experienced where a banking customer has accounts at multiple different banking institutions, the authenticating party would generally have a separate OTP token for each relying party. Accordingly, there is a need for a practical solution that addresses one or more of these challenges.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a high-level diagram illustrating interactions between an authenticating party having a OTP presenter of various type, and a plurality of relying devices, according to some embodiments described herein.

FIG. 2 is a block diagram illustrating an example OTP presenter and OTP verifier according to various embodiments.

FIG. 3 is a block diagram illustrating an exemplary system architecture of a processor-based computing device according to an embodiment.

FIG. 4 is a diagram illustrating an exemplary hardware and software architecture of a computing device such as the one depicted in FIG. 3, in which various interfaces between hardware components and software components are shown.

FIG. 5 is a block diagram illustrating examples of processing devices that may be implemented on a computer system, such as the computer system described with reference to FIGS. 3-4, according to some embodiments.

FIG. 6 is a block diagram illustrating example components of a CPU as one of the processing devices depicted in FIG. 5, according to various embodiments.

FIG. 7 is a flow diagram illustrating a process for obtaining a digital certificate, by an OTP presenter, from a certificate authority, according to some embodiments.

FIG. 8 is a flow diagram illustrating operations of OTP presenter relating to registration with a relying party's OTP verifier according to an embodiment.

FIG. 9 is a flow diagram illustrating registration-related operations carried out by OTP verifier of a relying party according to an example embodiment.

FIG. 10 is a flow diagram illustrating operations of an authentication transaction carried out by an OTP presenter according to an embodiment.

FIG. 11 is a flow diagram illustrating operations performed by an OTP verifier of a relying party during an authentication transaction, according to an embodiment.

### DETAILED DESCRIPTION

Aspects of the embodiments are directed to one-time password (OTP) devices, components thereof, systems incorporating OTP presenter, and associated methods of operation. In the present context, an OTP presenter is a device, or tangible component of a device or greater computer system, that is constructed, programmed, or otherwise configured, to execute OTP-related operations.

It will be understood that suitable a variety of implementations may be realized in which a OTP presenter is provided as a dedicated unit, or as part of a computing platform through the execution of program instructions. The computing platform may be one physical machine, or may be distributed among multiple physical machines, such as by role or function, or by process thread in the case of a cloud computing distributed model in various embodiments certain operations may run in virtual machines that in turn are executed on one or more physical machines. It will be understood by persons of skill in the art that features of the embodiments may be realized by a variety of different suitable machine implementations.

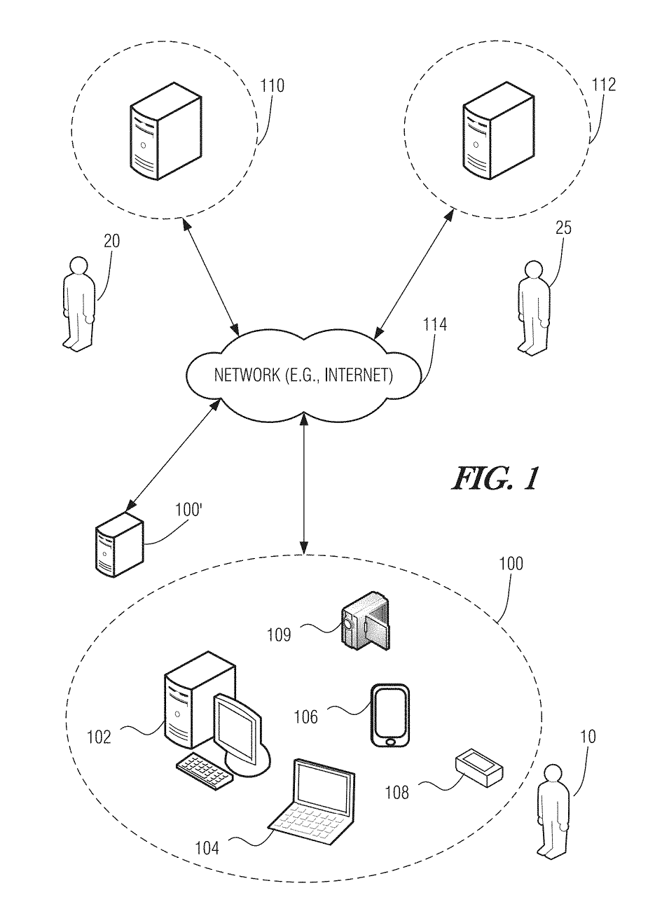

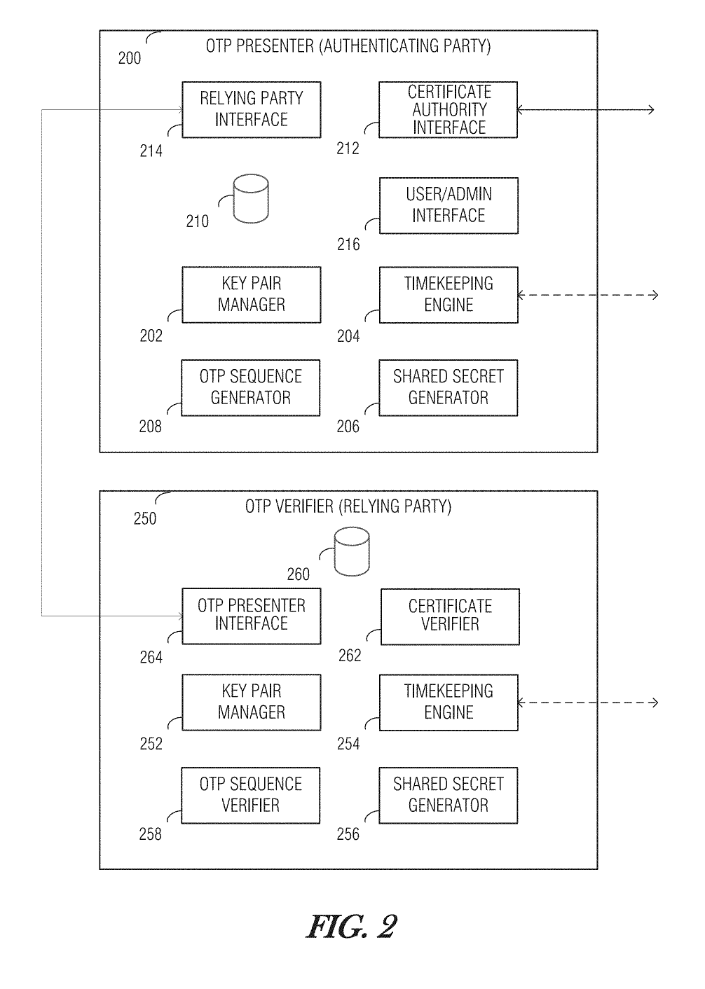

FIG. 1 is a high-level diagram illustrating interactions between an authenticating party 10 having an OTP presenter 100, 100′ of various type, and a plurality of relying parties 20, 25, according to some embodiments described herein. Authenticating party 10 is the party providing proof of authenticity using an OTP. Relying party 20 or relying party 25 receives the OTP-proof from authenticating party 10, validates the OTP and, if the OTP is determined to be valid, relies on the OTP as proof of authenticity of authenticating party 10. As illustrated, communications between authenticating party 10 and each relying party 20. 25 may be conducted over a communication network 114, such as the Internet, for example. In an authentication transaction, authenticating party 10 employs an OTP presenter 100, 100′ whereas relying party 20 employs an OTP verifier 110 and relying party 25 employs OTP verifier 112. The structure and operation of OTP presentation and verifiers are described in greater detail below with reference to FIGS. 2-11.

As depicted, a variety of device types may be utilized for implementing an OTP presenter 100, 100′ for authenticating party 10. Some non-limiting examples include personal computers, such as desktop PC 102, laptop 104, smartphone/tablet 106, and the like. Other types of information devices, such as OTP appliance 108, may be dedicated to OTP operations. OTP appliance 108 may also be referred to as a security token. OTP appliance 108 may include an alphanumeric display for showing a user an OTP that may be keyed manually entered into a transaction authentication session. An Internet of Things (IoT) device 109 may also host an OTP presenter 100 of authenticating party 10. Compared to personal computer-based implementations, OTP appliance 108 and IoT device 109 tend to have limited computational processing facilities that are sufficient to support OTP functionality and, in the case of IoT device 109, general operation; but the computing power in these devices is generally not sufficient for general-purpose computing.

In another arrangement according to some embodiments, a remote OTP presenter 100′ is implemented to provide a service, or agent, acting on behalf of the authenticating party. Remote OTP presenter 100′ may be realized on a server or cloud-based service.

In various OTP presenter configurations according to some embodiments, the OTP presenter 100 may be established in the computing device that the user of relying party 10 is employing to interact, or transact, with a relying party 20, 25, such as a PC, tablet, or the like. In other embodiments, the OTP presenter 100 may be in a separate device, such as a smartphone, dedicated device, or remotely-situated device, which may establish an independent channel of communication with the relying party 20, 25 in order to complete the OTP-based authentication transaction as an out-of-band communication apart from the main interaction or transaction to be protected via OTP-based authentication.

In a related embodiment, the OTP presenter 100, 100′ enforces a protocol that, for added protection, requires the user of authenticating party 10 to interact with the OTP presenter 100 to demonstrate physical possession of the OTP presenter 100. For instance, the OTP presenter 100 may require the authenticating party 10 user to press a key or activate a touch sensor, provide a fingerprint or other biometric indicator, enter a personal identification number (PIN), or the like, before the OTP presenter 100 will release an OTP sequence for an authentication session.

Some aspects of the embodiments utilize public-key cryptography properties to achieve a specific set of shared data that is unique to a relying party 20, 25 and the authenticating party's 10 OTP presenter 100, 100′, and which is used to form a transaction and time-dependent key. This unique key may be subsequently used to generate an OTP. One advantage of this aspect of the embodiments is that a single, trusted OTP presenter 100 may be issued to, or established for, clients (via their connected computer, mobile device, an Internet of Things (IoT) device), and this single OTP presenter 100 may work with multiple relying parties.

When a relying patty 20, 25 wishes to transact with a previously-issued OTP presenter 100, the relying party may simply establish a relationship with the existing OTP presenter 100 (rather than having to undergo a new OTP presenter issuance process, as is the typical case with conventional systems). Once a relying party 20, 25 has associated its OTP verifier 110, 112 with an OTP presenter 100, it may subsequently use the obtained information to validate one-time-passwords that the OTP presenter 100 generates based on the established relationship and a mutually-known variable, such as the current time, for example. Notably, each generated OTP sequence is not usable at other relying parties who may have also registered with the same OTP presenter 100, since each relying party is requires a corresponding unique shared secret that is used to form the transaction keying material.

FIG. 2 is a block diagram illustrating an example OTP presenter 200, and OTP verifier, according to various embodiments. OTP presenter 200 may be a shared OTP presenter implemented in a trusted computing element. The trusted computing element may be implemented in a variety of host devices, such as, for example a discrete, trusted execution device (such as a caretaker processor—described in greater detail below), or in a virtualized trusted execution environment (TEE) such as, for example, a TEE implemented using Software Guard eXtensions (SGX) technology.

OTP presenter 200 includes an asymmetric key pair manager 202, timekeeping engine 204, OTP sequence generator 206, shared secret generator 208, database 210, certificate authority interface 212, relying party interface 214, and user/administrator interface 216.

OTP verifier 250 includes key pair manager 252, timekeeping engine 254, shared secret generator 256, OTP sequence verifier 258, database 260, certificate verifier 262, and OTP presenter interface 264.

In various embodiments, these components are implemented as engines, circuits, components, or modules, which for the sake of consistency are termed engines, although it will be understood that these terms may be used interchangeably. Engines may be hardware, software, or firmware communicatively coupled to one or more processors in order to carry out the operations described herein. Engines may be hardware engines, and as such engines may be considered tangible entities capable of performing specified operations and may be configured or arranged in a certain manner. In an example, circuits may be arranged (e.g., internally or with respect to external entities such as other circuits) in a specified manner as an engine. In an example, the whole or part of one or more hardware processors may be configured by firmware or software (e.g., instructions, an application portion, or an application) as a engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which engines are temporarily configured, each of the engines need not be instantiated at any one moment in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

Key pair manager 202 of OTP presenter 200 is programmed, or otherwise configured, to generate or obtain a pair of asymmetric cryptographic keys produced using such procedures as RSA or elliptic curve cryptosystem techniques. The asymmetric key pair may include a public key that is shared externally, and a private key, which is known only by OTP presenter 200.

Timekeeping engine 204 is programmed, or otherwise configured, to provide access to a stable and trusted time source. This time source may be provided by an internal circuit (e.g., an embedded real-time-clock) or via a trusted external service such as trusted Network Time Protocol (NTP) defined in Internet RFCs 1405 and 6905.

Shared secret generator 206 is constructed, programmed, or otherwise configured, to produce a value, or associated pair of values, that are unique to an established trust relationship between OTP presenter 200 and a relying party. This value or associated pair of values is referred to as a shared secret, and in one type of embodiment is based on the public and private keys of OTP presenter 200 as the authenticating party and the corresponding relying party, as will be discussed in greater detail below.

OTP sequence generator 208 is constructed, programmed, or otherwise configured, to generate different one-time-use codes to authenticate OTP presenter 200 as the authenticating party. The one-time use codes are based on the shared secret and on a mutually-known changing value between OTP presenter 200 and the corresponding relying party, such as the current time e.g., available via timekeeping engine 204.

Database 210 is configured to securely store the asymmetric key pair, the shared secret, and other items of information essential to the operation of OTP presenter 200.

Certificate authority interface 212 is constructed, programmed, or otherwise configured to conduct a communication protocol with a certificate authority to obtain a digital certificate attesting to the integrity of OTP presenter 200. The public key of OTP presenter 200, the signature of the certificate authority, and a representation of the certificate authority are combined into a certificate that is stored in an isolated data store arranged via database 210.

Relying party interface 214 is constructed, programmed, or otherwise configured, to conduct a communications protocol with each relying party using a generated OTP sequence that is unique to each authentication session. The communication protocol may include a registration portion, and an authentication transaction portion, as will be described in greater detail below.

User/administrator interface 216 is constructed, programmed, or otherwise configured, to obtain input from a user or administrator of OTP presenter 200. As an example of user input obtained via user/administrator input 216, a user of the authenticating party may provide input in order to demonstrate the user' s physical possession of the host device of OTP presenter 200. As an example of input from an administrator, an issuer of OTP presenter 200 main command OTP presenter 200 to perform an initialization process. In various embodiments, user/administrator interface 200 may be coupled to a local user interface of a host system (e.g., an operating system shell), or a remote interface via networking facilities.

OTP verifier 250 may be implemented in a trusted computing environment, or may be implemented with a general-purpose computing platform according to various embodiments. OTP verifier 250 includes key pair manager 252 that is programmed, or otherwise configured, to generate or obtain a pair of asymmetric cryptographic keys produced using such procedures as RSA or elliptic curve cryptosystem techniques. The asymmetric key pair may include a public key that is shared externally, and a private key, which is known only by OTP verifier 250. As will be described in greater detail below, key pair manager 252 may produce static, or ephemeral key pairs, with the latter being produced specifically for a particular authentication transaction with an OTP presenter 200.

Timekeeping engine 254, similar to timekeeping engine 204, is programmed, or otherwise configured, to provide access to a stable and trusted time source (which may be provided by an internal circuit or via a trusted external service). Shared secret generator 256 is constructed, programmed, or otherwise configured, to produce a value, or associated pair of values, that are unique to an established trust relationship between OTP verifier 250 and an authenticating party. This value or associated pair of values is referred to as a shared secret, and in one type of embodiment is based on the public and private keys of OTP verifier 250 as the relying party and the corresponding authenticating party, as will be discussed in greater detail below.

OTP sequence verifier 258 is constructed, programmed, or otherwise configured, to verify one-time-use codes provided to authenticate OTP presenter 200 as an authenticating party, as will be described in greater detail below.

Database 260 is configured to securely store the asymmetric key pair, the shared secret, information provided by OTP presenter 200, and other items of information essential to the operation of OTP verifier 250.

Certificate verifier 262 is constructed, programmed, or otherwise configured, to verify the validity of digital certificates presented to OTP verifier 250 based on the public key of the certificate authority, which is a trusted issuer of the certificate.

OTP presenter interface 264 is constructed, programmed, or otherwise configured, to exchange information with OTP presenter 200 according to registration and authentication protocols, as will be described below.

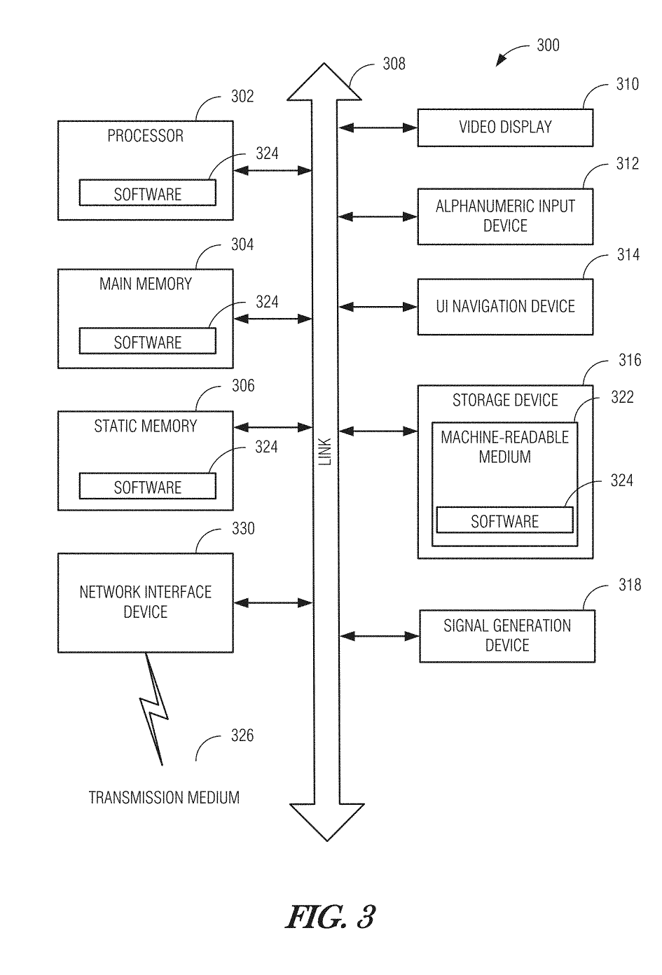

FIG. 3 is a block diagram illustrating a computer system 300 in the example form of a general-purpose machine. In certain embodiments, programming of the computer system 300 according to one or more particular algorithms produces a special-purpose machine upon execution of that programming, to form OTP presenter 200, or OTP verifier 250. In a networked deployment, the computer system 300 may operate in the capacity of either a server or a client machine in server-client network environments, or it may act as a peer machine in peer-to-peer (or distributed) network environments.

Example computer system 300 includes at least one processor 302 (e.g., a central processing unit (CPU), a graphics processing unit (GPU) or both, processor cores, compute nodes, etc.), a main memory 304 and a static memory 306, which communicate with each other via a link 308 (e.g., bus). The computer system 300 may further include a video display unit 310, an alphanumeric input device 312 (e.g., a keyboard), and a user interface (UI) navigation device 314 (e.g., a mouse). In one embodiment, the video display unit 310, input device 312 and UI navigation device 314 are incorporated into a touch screen display. The computer system 300 may additionally include a storage device 316 (e.g., a drive unit), a signal generation device 318 (e.g., a speaker), a network interface device (NID) 320, and one or more sensors (not shown), such as a global positioning system (GPS) sensor, compass, accelerometer, or other sensor.

The storage device 316 includes a machine-readable medium 322 on which is stored one or more sets of data structures and instructions 324 (e.g., software) embodying or utilized by any one or more of the methodologies or functions described herein. The instructions 324 may also reside, completely or at least partially, within the main memory 304, static memory 306, and/or within the processor 302 during execution thereof by the computer system 300, with the main memory 304, static memory 306, and the processor 302 also constituting machine-readable media.

While the machine-readable medium 322 is illustrated in an example embodiment to be a single medium, the term “machine-readable medium” may include a single medium or multiple media (e.g., a centralized or distributed database, and/or associated caches and servers) that store the one or more instructions 324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

NID 330 according to various embodiments may take any suitable form factor. In one such embodiment, NID 320 is in the form of a network interface card (NIC) that interfaces with processor 302 via link 308. In one example, link 308 includes a PCI Express (PCIe) bus, including a slot into which the MC form-factor may removably engage. In another embodiment, NID 320 is a network interface circuit laid out on a motherboard together with local link circuitry, processor interface circuitry, other input/output circuitry, memory circuitry, storage device and peripheral controller circuitry, and the like. In another embodiment, NID 320 is a peripheral that interfaces with link 308 via a peripheral input/output port such as a universal serial bus (USB) port. NID 320 transmits and receives data over transmission medium 326, which may be wired or wireless (e.g., radio frequency, infra-red or visible light spectra, etc.), fiber optics, or the like.

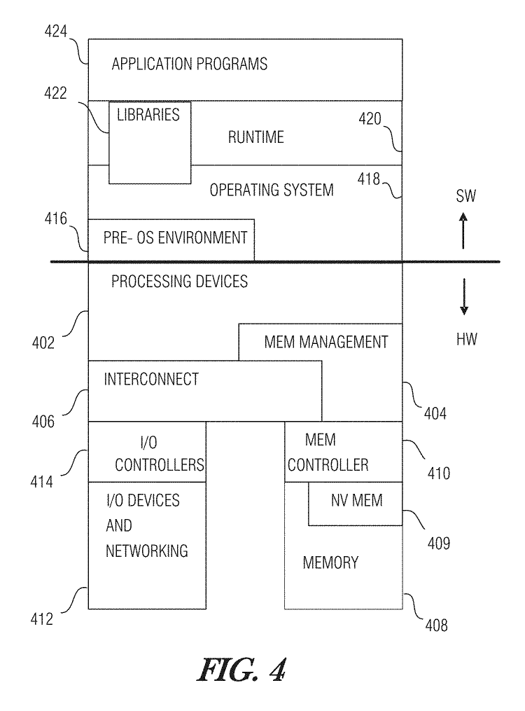

FIG. 4 is a diagram illustrating an exemplary hardware and software architecture of a computing device such as the one depicted in FIG. 3, in which various interfaces between hardware components and software components are shown. As indicated by HW, hardware components are represented below the divider line, whereas software components denoted by SW reside above the divider line. On the hardware side, processing devices 402 (which may include one or more microprocessors, digital signal processors, etc., each having one or more processor cores, are interfaced with memory management device 404 and system interconnect 406. Memory management device 404 provides mappings between virtual memory used by processes being executed, and the physical memory. Memory management device 404 may be an integral part of a central processing unit which also includes the processing devices 402.

Interconnect 406 includes a backplane such as memory, data, and control lines, as well as the interface with input/output devices, e.g., PCI, USB, etc. Memory 408 (e.g., dynamic random access memory—DRAM) and non-volatile memory 409 such as flash memory (e.g., electrically-erasable read-only memory—EEPROM, NAND Flash, NOR Flash, etc.) are interfaced with memory management device 404 and interconnect 406 via memory controller 410. This architecture may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 412, which interface with interconnect 406 via corresponding I/O controllers 414.

On the software side, a pre-operating system (pre-OS) environment 416, which is executed at initial system start-up and is responsible for initiating the boot-up of the operating system. One traditional example of pre-OS environment 416 is a system basic input/output system (BIOS). In present-day systems, a unified extensible firmware interface (UEFI) is implemented. Pre-OS environment 416, is responsible for initiating the launching of the operating system, but also provides an execution environment for embedded applications according to certain aspects of the invention.

Operating system (OS) 418 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 418 provides device drivers, and a variety of common services such as those that facilitate interfacing with peripherals and networking, that provide abstraction for application programs so that the applications do not need to be responsible for handling the details of such common operations. Operating system 418 additionally provides a graphical user interface (GUI) that facilitates interaction with the user via peripheral devices such as a monitor, keyboard, mouse, microphone, video camera, touchscreen, and the like.

Runtime system 420 implements portions of an execution model, including such operations as putting parameters onto the stack before a function call, the behavior of disk input/output (I/O), and parallel execution-related behaviors. Runtime system 420 may also perform support services such as type checking, debugging, or code generation and optimization.

Libraries 422 include collections of program functions that provide further abstraction for application programs. These include shared libraries, dynamic linked libraries (DLLs), for example. Libraries 422 may be integral to the operating system 418, runtime system 420, or may be added-on features, or even remotely-hosted. Libraries 422 define an application program interface (API) through which a variety of function calls may be made by application programs 424 to invoke the services provided by the operating system 418. Application programs 424 are those programs that perform useful tasks for users, beyond the tasks performed by lower-level system programs that coordinate the basis operability of the computing device itself.

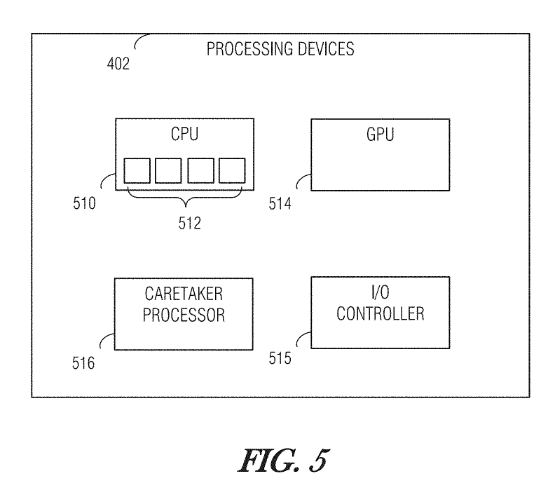

FIG. 5 is a block diagram illustrating processing devices 402 according to some embodiments. In one embodiment, two or more of processing devices 402 depicted are formed on a common semiconductor substrate. CPU 510 may contain one or more processing cores 512, each of which has one or more arithmetic logic units (ALU), instruction fetch unit, instruction decode unit, control unit, registers, data stack pointer, program counter, and other essential components according to the particular architecture of the processor. As an illustrative example, CPU 510 may be a x86-type of processor. Processing devices 402 may also include a graphics processing unit (GPU) 514. In these embodiments, GPU 514 may be a specialized co-processor that offloads certain computationally-intensive operations, particularly those associated with graphics rendering, from CPU 510. Notably, CPU 510 and GPU 514 generally work collaboratively, sharing access to memory resources, I/O channels, etc.

Processing devices 402 may also include caretaker processor 516 in some embodiments. Caretaker processor 516 generally does not participate in the processing work to carry out software code as CPU 510 and GPU 514 do. In some embodiments, caretaker processor 516 does not share memory space with CPU 510 and GPU 514, and is therefore not arranged to execute operating system or application programs. Instead, caretaker processor 516 may execute dedicated firmware that supports the technical workings of CPU 510, GPU 514. and other components of the computer system. In some embodiments, caretaker processor is implemented as a microcontroller device, which may be physically present on the same integrated circuit die as CPU 510, or may be present on a distinct integrated circuit die. Caretaker processor 516 may also include a dedicated set of I/O facilities to enable it to communicate with external entities. In one type of embodiment, caretaker processor 516 is implemented using a manageability engine (ME) or platform security processor (PSP). Input/output (I/O) controller 515 coordinates information flow between the various processing devices 510, 514, 516, as well as with external circuitry, such as a system interconnect.

In some embodiments, OTP presenter 200 is implemented using. caretaker processor 516. In these embodiments, the isolation of data storage, processing, and communication facilities of caretaker processor 516 from CPU 510 provide protection for OTP presenter 200 from malware that may have compromised the code executed on CPU 510.

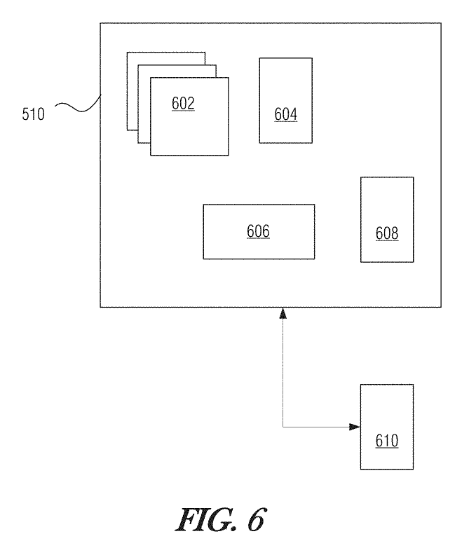

FIG. 6 is a block diagram illustrating example components of CPU 510 according to various embodiments. As depicted, CPU 510 includes one or more cores 602, cache 604, and CPU controller 606, which coordinates interoperation and tasking of the core(s) 602, as well as providing an interface to facilitate data flow between the various internal components of CPU 510, and with external components such as a memory bus or system interconnect. In one embodiment, all of the example components of CPU 510 are formed on a common semiconductor substrate.

CPU 510 includes non-volatile memory 608 (e.g., flash, EEPROM, etc.) for storing certain portions of foundational code, such as an initialization engine, and microcode. Also. CPU 510 may be interfaced with an external (e.g., formed on a separate IC) non-volatile memory device 610 that stores foundational code that is launched by the initialization engine, such as system BIOS or UEFI code.

In the embodiment depicted, CPU 510 is configured to provide an Isolated Execution Environment (IEE). In one example IEE, the CPU, at boot time, loads a particular piece of code into its internal memory. Before that code may be executed, the CPU computes a hash of the code, and either compares that hash to a value stored in hardware, or performs a digital signature validation on the hash using a public key in which either the public key or a hash of the public key is stored in the CPU. If the check passes, then the CPU proceeds with execution according to the privileges of the code. The privileges could be stored in the CPU along with the hash of the code, or they could be included in the code itself.

The privileges may include access to restricted resources such as secret keys in the CPU. The CPU then allows this code to execute with the allowed privileges. It does not allow any other code to execute until the particular code has finished, and access to the restricted resources have been restricted. The CPU may force a reboot instead of allowing any execution after the code execution has finished.

In some embodiments where OTP presenter 200 is implemented using CPU 510, an IEE is utilized to provide protected data and process execution of database 210, and engines 202-208 (having access to the OTP presenter's private key or timekeeping).

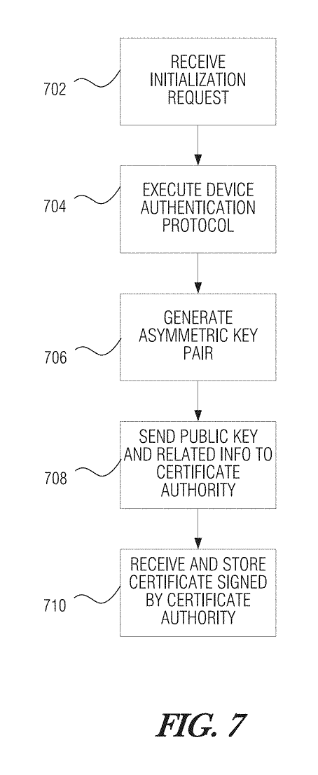

FIGS. 7-11 are flow diagrams illustrating operations performed by OTP presenter 200 and OTP verifier 250 according to various embodiments. It is important to note that the processes are richly-featured embodiments that may be realized as described; in addition, portions of the processes may be implemented while others are excluded in various embodiments. The following Additional Notes and Examples section details various combinations, without limitation, that are contemplated. It should also be noted that in various embodiments, certain process operations may be performed in a different ordering than depicted in FIGS. 7-9, provided that the logical flow and integrity of the process is not disrupted in substance.

Turning first to FIG. 7, a process for obtaining a digital certificate, by OTP presenter 200, from a certificate authority is depicted according to an illustrative embodiment. The certificate represents the fact that a trusted authority has previously authenticated OTP presenter 200. At 702, OTP presenter 200 receives an initialization request. This request may be provided by an issuer of the OTP presenter 200, such as a financial institution, a secure computing services provider, or the like. In response to the initialization request, at 704, OTP presenter 200 executes a device authentication protocol via certificate authority interface 212. Any suitable authentication protocol may be employed, for example a SIGMA-based protocol.

At 706, key pair manager 202 generates an asymmetric key pair. In an embodiment, the asymmetric key pair is randomly generated locally by key pair manager 202. In a related embodiment, the key pair or the seed for generation of the key pair is obtained from an external source. In an embodiment, the key pair is an elliptic curve key pair. In another embodiment, the key pair is an RSA key pair. The key pair includes a public key and a private key.

At 708, the public key, along with any additional pertinent information, such as the key parameters, the device ID, and the like), are sent to the certificate authority via certificate authority interface 212. The certificate authority constructs a certificate structure that includes the OTP presenter's public key and other pertinent information, and then signs the certificate with its (the certificate authority's) private key, thereby attesting to its creation of the certificate. The result is a signed certificate that can be validated by relying parties. In an example, an X.509 public certificate format is utilized. In other embodiments, other forms of certificate are contemplated. In one such example, compact certificates as used by Europay, MasterCard and Visa (EMV) payment systems and Federal Information Processing Standards (PIPS) 201-based identity systems may be used.

At 710, OTP presenter 200 receives the signed certificate via certificate authority interface 212, and stores the certificate in database 210. Thereafter, when a relying party wishes to enter into a registration process with OTP presenter 200, the OTP presenter presents the certificate.

In another embodiment, the authentication and issuance of the certificate may be implicit by virtue of the device manufacturing process. For instance, the certificate issuance may be included when the OTP device circuitry is being fabricated or assembled.

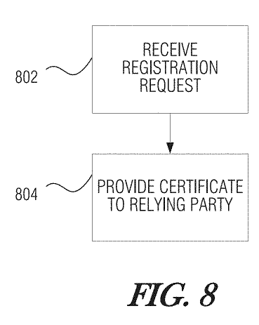

FIG. 8 is a flow diagram illustrating operations of OTP presenter 200 relating to registration with a relying party's OTP verifier according to an embodiment. Whenever a relying party wishes to exercise additional user verification through the use of OTP factors the relying party may initiate a client registration request. This registration process is generally used to provide an association between the authenticating individual and OTP presenter 200 in the possession or under control of that individual. Once an OTP presenter is registered in can provide an additional factor to authentication attempts to the relying party by demonstrating individual possession or control of OTP presenter 200.

The relying party may request for OTP presenter 200 to provide its signed certificate. At 802, the registration request is received via relying party interface 214. At 804, in response to the request, relying party interface 214 retrieves the certificate from database 210, and supplies the certificate to the requestor.

In a related embodiment, to assure that OTP presenter 200 is in control of the private key associated with the certificate's public key, the registration request might also contain random challenge data that the presenter signs using its corresponding private key. Upon receiving the certificate and signed data the relying party can then verify that the signature properly corresponds with the supplied certificate public key.

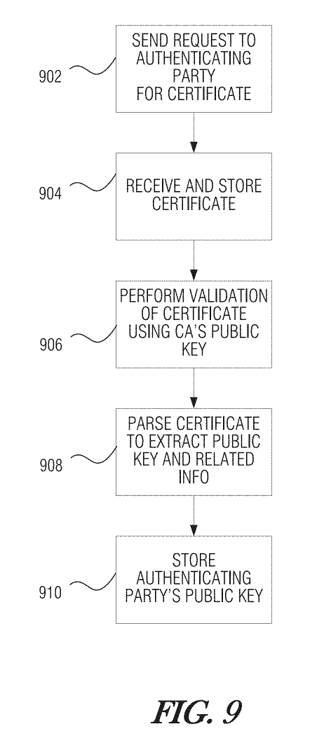

FIG. 9 is a flow diagram illustrating registration-related operations carried out by OTP verifier of a relying party according to an example embodiment. At 902, OTP presenter interface 264 sends a request to the authenticating party's OTP presenter to provide a digital certificate signed by a trusted certificate authority. Commensurate with the request, relying party interface 214 receives the public key of the relying party. At 904, the certificate is received from the OTP presenter and stored in database 260. At 906, certificate verifier 262 checks the validity of the certificate using the public key of the certificate authority (CA) that signed the certificate. At 908, certificate verifier 262 parses the certificate to extract its contents, including the public key of the OTP presenter, from which the shared secret is to be generated in a later operation during authentication of OTP presenter 200. At 910, the public key of the authenticating party is stored in database 260 for future use.

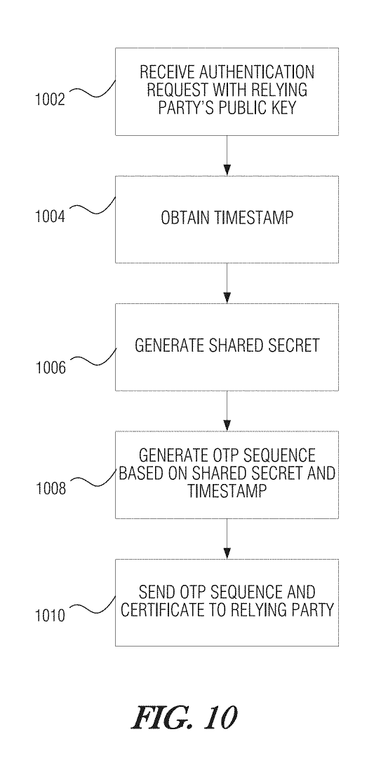

FIG. 10 is a flow diagram illustrating operations of an authentication transaction carried out by OTP presenter 200 according to an embodiment. At 1002, OTP presenter 200 receives an authentication request. At 1004, timekeeping engine 204 of OTP presenter 200 provides a timestamp for use with the authentication transaction. The timestamp may be generated locally by timekeeping engine 204 in one embodiment. In another embodiment, the timestamp may be obtained from an external timekeeping service by timekeeping engine 204.

At 1006, shared secret generator 206 generates a shared secret based on the relying party's public key and on the private key of OTP presenter 200 previously generated by key pair manager 202. In one example approach, an Elliptic Curve Diffie-Hellman algorithm, such as described in ANSI X9.63 (2011) is used to form the shared secret. The relying party is able to produce its own copy of the shared secret based on the relying party's private key and the public key of MT presenter 200.

At 1008, OTP sequence generator 208 generates a time- and party-dependent OTP sequence based on the shared secret and on the timestamp. In an embodiment, the OTP sequence is a cryptographic hash of the shared secret, concatenated with the timestamp. In a related embodiment, a sequence number may also be concatenated with the shared secret and timestamp as follows:

OTPSeq=Hash(Z∥N∥T).

where Hash( ) represents a cryptographic hashing operation using an algorithm such as SHA-256, SHA-1, MD5, or the like; Z represents the shared secret, N represents a sequence index number (e.g., 0001, 0002, etc.), T represents the timestamp value, and ∥ represents byte-level concatenation of these values.

In a related embodiment, a data-reduction technique may be used to shorten the OTP sequence for use in embodiments where a human user is to type in the generated OTP sequence into a password field of a Web page, for example, from a value displayed via user/administrator interface 216 and a display device of the host device of OTP presenter 200. An example of a data-reduction technique may be to select every third digit of the hash value, for instance.

At 1010, the OTP sequence and digital certificate obtained at operation 710 (FIG. 7) are sent to the relying party. The relying party verifies that the supplied certificate is the one previously registered to OTP device 200, and obtains a timestamp representing the current time.

In a related embodiment, a hash of the digital certificate's public key is used as a “handle” to the certificate stored in the verifier's database 210. During operation 1010 the OTP sequence and the public key hash value (in lieu of the entire certificate) are sent to the relying party. Using the provided hash as a key/index the relying party obtains the certificate to access the public key associated with the authenticating party for subsequent verification purposes.

Notably, although OTP presenter 200 may be configured with a static pair of asymmetric keys, it is able to generate unique OTP sequences with different relying parties, since each relying party supplies its own specific public key, which is optionally ephemeral, making it unique to the transaction.

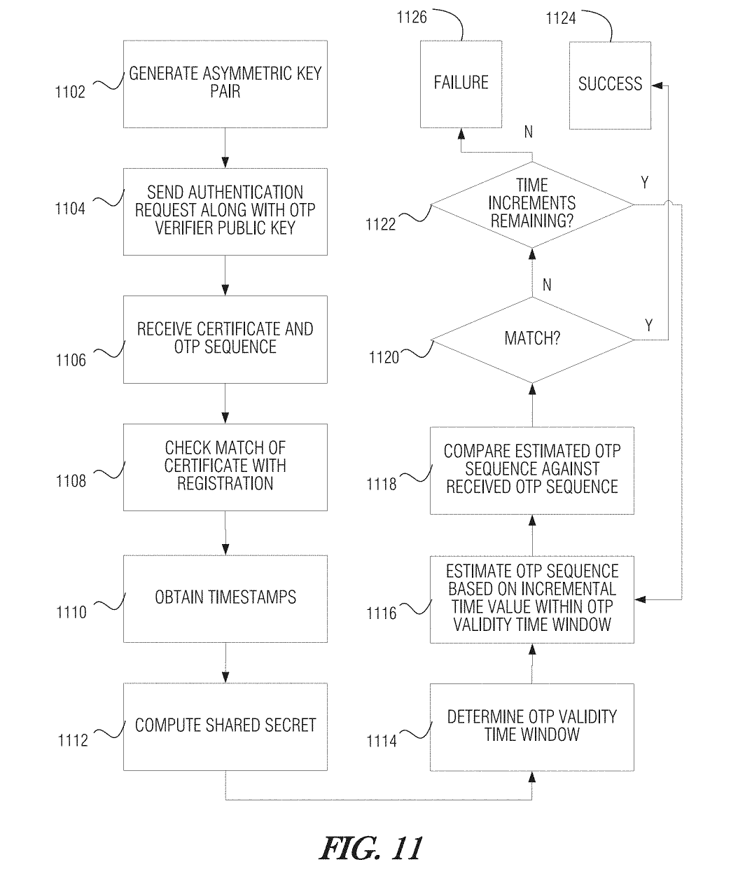

FIG. 11 is a flow diagram illustrating operations performed by OTP verifier 250 of a relying party during an authentication transaction, according to an embodiment. The process begins at 1102, where in response to a determined need to perform authentication of OTP presenter 200, key pair manager 252 of OTP verifier 250 generates an asymmetric key pair to be used in forming a secret. The asymmetric key pair includes a public key and a private key. The key pair may be an elliptic curve key pair, or another suitable type of asymmetric key pair. In various embodiments, the key pair may be either static or ephemeral. A statically-generated key pair is one key pair manager 252 generates in advance, and maintains for future use and re-use. A dynamically-generated key pair is generated specifically for a particular transaction, and is generated very close in time e.g., “just in time”) prior to an authentication transaction. The dynamically-generated key pair can provide improved security against man-in-the-middle types of attacks, though it is also associated with increased computational expense and transaction latency.

At 1104, OTP presenter interface 264 sends an authentication request along with the generated public key of OTP verifier 250, to OTP presenter 200. At 1106, OTP verifier interface 264 receives the digital certificate signed by the certificate authority and a generated OTP sequence based on the shared secret, from OTP presenter 200 in response to the authentication request.

At 1108, certificate verifier 262 checks whether the certificate is the same certificate that was previously registered in the processes of FIGS. 8-9. If the certificate is not the same as the registered one, the authentication transaction may be terminated due to a failure of certificate verification. If the certificate matches the registration, the process advances to 1110, where timekeeping engine 254 obtains a series of timestamps within a time window preceding the current time.

At 1112, shared secret generator 526 uses the OTP presenter's public key from the certificate and the private key of OTP verifier 250 to compute the shared secret value Z. At 1114, OTP sequence verifier 528 determines a time window over which the OTP sequence is considered valid. This time window may be in the range of some fraction of a second to several seconds according to an example embodiment. More generally, the time window corresponds to an expected rime duration between the timestamp obtained by OTP presenter 200 at operation 1004, and receipt of the certificate and OTP sequence at 1106. In a related embodiment, the time window is based on the time of execution of operation 1104 and the time of execution of operation 1106.

At 1116, OTP sequence verifier iteratively computes the estimates of the OTP sequence over the selected time window using the same computation as is used by OTP presenter 200 to generate the OTP sequence (e.g., Elliptic Curve Diffie-Hellman Z value, concatenated with sequence number and timestamp, then cryptographically hashed, and size-reduced, if applicable). At 1118, each estimated OTP sequence is checked against the received OTP sequence. If a match is found at decision 1120, the authentication transaction may be deemed successful, and terminated at 1124. If a match is not found, the process advances to decision 1122, where OTP sequence verifier determines whether any further time increments of the time window remain for further OTP sequence estimation attempts. If time increments remain, the process loops back to operation 1116 to compute the next estimated OTP sequence. If a match over the time window is not found, the authentication transaction is deemed a failure at 1126.

### Additional Notes & Examples:

Example 1 is an apparatus for one-time password (OTP) transactions with a relying party, the apparatus comprising: a key pair manager to access a set of asymmetric cryptographic keys including a public key and a private key; a relying party interface to receive a public key of a first relying party; a shared secret generator to generate a first shared secret value based on the private key and on the public key of the first relying party in response to a first OTP production request; and an OTP sequence generator to generate a first OTP sequence based on the first shared secret value in response to the first OTP production request, wherein the first OTP sequence is unique to the first relying party and to the first OTP production request.

In Example 2, the subject matter of Example 1 optionally includes computing hardware including circuitry configured to implement the key pair manager, the relying party interface, the shared secret generator, and the OTP sequence generator.

In Example 3, the subject matter of any one or more of Examples 1-2 optionally include computing hardware including a processor configured to implement an isolated execution environment in which the key pair manager, the relying party interface, the shared secret generator, and the OTP sequence generator are implemented.

In Example 4, the subject matter of any one or more of Examples 1-3 optionally include wherein the asymmetric keys include an elliptic curve key pair.

In Example 5, the subject matter of any one or more of Examples 1-4 optionally include a certificate authority interface to receive, from a certificate authority, a digital certificate that includes the public key of the set of asymmetric keys, and wherein the digital certificate is signed by the certificate authority.

In Example 6, the subject matter of Example 5 optionally includes wherein the relying party interface is to conduct a registration process wherein the digital certificate is provided to the relying party in advance of any OTP authentication transaction.

In Example 7, the subject matter of any one or more of Examples 1-6 optionally include a timekeeping engine to produce a first timestamp based on a current time; and wherein the OTP sequence generator is to generate the first OTP sequence based on the first timestamp.

In Example 8, the subject matter of Example 7 optionally includes wherein the timekeeping engine includes a real-time clock circuit that locally provides current time information for the first timestamp.

In Example 9, the subject matter of any one or more of Examples 7-8 optionally include wherein the timekeeping engine includes an interface with a remote timekeeping service that provides current time information for the first timestamp.

In Example 10, the subject matter of any one or more of Examples 7-9 optionally include wherein the first OTP sequence is based on a combination of at least the first shared secret value and the first timestamp.

In Example 11, the subject matter of Example 10 optionally includes wherein the first OTP sequence is based on a cryptographic hash of the combination of at least the first shared secret value and the first timestamp.

In Example 12, the subject matter of Example 11 optionally includes wherein the first OTP sequence is based on a cryptographic hash of a combination of the first shared secret value, the first timestamp, and a sequence index number.

In Example 13, the subject matter of any one or more of Examples 7-12 optionally include wherein the first OTP sequence is a data-reduced value derived from the cryptographic hash of the combination of at least the first shared secret value and the first timestamp.

In Example 14, the subject matter of any one or more of Examples 1-13 optionally include wherein the public key of the first relying party is ephemeral.

In Example 15, the subject matter of any one or more of Examples 1-14 optionally include wherein the OTP production request is originated by the first relying party.

In Example 16, the subject matter of any one or more of Examples 1-15 optionally include wherein the relying party interface is to receive a public key of a second relying party that is distinct from the public key of the first relying party; and wherein the shared secret generator is to generate a second shared secret value based on the private key and on the public key of the second relying party in response to a second OTP production request; and wherein the OTP sequence generator is to generate a second OTP sequence based on the second shared secret value in response to the second OTP production request, wherein the second OTP sequence is unique to the second relying party and to the second OTP production request.

Example 17 is an apparatus for one-time password (OTP) transactions with an authenticating party, the apparatus comprising: a key pair manager to access a set of asymmetric cryptographic keys including a public key and a private key; an OTP presenter interface to send a first OTP production request and the public key to the authenticating party, and to receive a first OTP sequence from the authenticating party in response to the first OTP production request, the first OTP sequence being based on a first shared secret value, and being unique to the authenticating party and to the first OTP production request, wherein the first shared secret value is based on the public key and on a private key of the authenticating party; a shared secret generator to locally generate a verification copy of the first shared secret value based on the private key and on the public key of the authenticating party; and an OTP sequence verifier to locally generate a verification copy of the first OTP sequence based on the verification copy of the first shared secret value, and to compare the first OTP sequence received in response to the first OTP production request against the verification copy of the first OTP sequence to produce a comparison result, wherein in response to the comparison result indicating a match the first OTP sequence is deemed verified.

In Example 18, the subject matter of Example 17 optionally includes wherein the key pair manager is to dynamically generate the asymmetric cryptographic keys in response to a call for processing of a transaction, such that the public key and the private key are unique to the transaction.

In Example 19, the subject matter of any one or more of Examples 17-18 optionally include computing hardware including circuitry configured to implement the key pair manager, the OTP presenter interface, the shared secret generator, and the OTP sequence verifier.

In Example 20, the subject matter of any one or more of Examples 17-19 optionally include computing hardware including a processor configured to implement an isolated execution environment in which the key pair manager, the OTP presenter interface, the shared secret generator, and the OTP sequence verifier are implemented.

In Example 21, the subject matter of any one or more of Examples 17-20 optionally include wherein the asymmetric keys include an elliptic curve key pair.

In Example 22, the subject matter of any one or more of Examples 17-21 optionally include a certificate verifier to verify authenticity of an issuer of a digital certificate that includes the public key of the authenticating party, and wherein the digital certificate is signed by the issuer of the digital certificate.

In Example 23, the subject matter of Example 22 optionally includes wherein the OTP presenter interface is to conduct a registration process wherein the digital certificate is received, and the public key of the authenticating party is extracted from the digital certificate and stored locally on the apparatus.

In Example 24, the subject matter of any one or more of Examples 17-23 optionally include a timekeeping engine to produce a series of timestamps in a time window preceding a current time and wherein the OTP sequence verifier is to generate the estimates of the first OTP sequence based on at least a portion of the series of timestamps, wherein the verification copy of the first OTP sequence is one of the estimates.

In Example 25, the subject matter of Example 24 optionally includes wherein the timekeeping engine includes a real-time clock circuit that locally provides current time information for the series of timestamps.

In Example 26, the subject matter of any one or more of Examples 24-25 optionally include wherein the timekeeping engine includes an interface with a remote timekeeping service that provides current time information for the series of timestamps.

In Example 27, the subject matter of any one or more of Examples 24-26 optionally include wherein the verification copy of the first OTP sequence is based on a combination of at least the verification copy of the first shared secret value and a first timestamp from among the series of timestamps.

In Example 28, the subject matter of Example 27 optionally includes wherein the verification copy of the first OTP sequence is based on a cryptographic hash of the combination of at least the verification copy of the first shared secret value and the first timestamp.

In Example 29, the subject matter of Example 28 optionally includes wherein the verification copy of the first OTP sequence is based on a cryptographic hash of the combination of the verification copy of the first shared secret value, the first timestamp, and a sequence index number.

In Example 30, the subject matter of any one or more of Examples 24-29 optionally include wherein the verification copy of the first OTP sequence is a data-reduced value derived from the cryptographic hash of the combination of at least the verification copy of the first shared secret value and a timestamp value from among the series of timestamps.

Example 31 is a machine-implemented method for one-time password (OTP) transactions with a relying party, the method being carried out by computing hardware of an OTP presenter device, the method comprising: generating a set of asymmetric cryptographic keys including a public key and a private key; receiving a public key of a first relying party; generating a first shared secret value based on the private key and on the public key of the first relying party in response to a first OTP production request; and generating a first OTP sequence based on the first shared secret value in response to the first OTP production request, wherein the first OTP sequence is unique to the first relying party and to the first OTP production request.

In Example 32, the subject matter of Example 31 optionally includes wherein the asymmetric keys include an elliptic curve key pair.

In Example 33, the subject matter of any one or more of Examples 31-32 optionally include receiving, from a certificate authority, a digital certificate that includes the public key of the set of asymmetric keys, and wherein the digital certificate is signed by the certificate authority.

In Example 34, the subject matter of Examples 33 optionally includes conducting a registration process wherein the digital certificate is provided to the relying party in advance of any OTP authentication transaction.

In Example 35, the subject matter of any one or more of Examples 31-34 optionally include producing a first timestamp based on a current time; and generating the first OTP sequence based on the first timestamp.

In Example 36, the subject matter of Example 35 optionally includes wherein producing the first timestamp is performed locally.

In Example 37, the subject matter of any one or more of Examples 35-36 optionally include wherein the first OTP sequence is based on a combination of at least the first shared secret value and the first timestamp.

In Example 38, the subject matter of Example 37 optionally includes wherein the first OTP sequence is based on a cryptographic hash of the combination of at least the first shared secret value and the first timestamp.

In Example 39, the subject matter of Example 38 optionally includes wherein the first OTP sequence is based on a cryptographic hash of a combination of the first shared secret value, the first timestamp, and a sequence index number.

In Example 40, the subject matter of any one or more of Examples 35-39 optionally include wherein the first OTP sequence is a data-reduced value derived from the cryptographic hash of the combination of at least the first shared secret value and the first timestamp.

In Example 41, the subject matter of any one or more of Examples 31-40 optionally include wherein the public key of the first relying party is ephemeral.

In Example 42, the subject matter of any one or more of Examples 31-41 optionally include wherein the OTP production request is originated by the first relying party.

In Example 43, the subject matter of any one or more of Examples 31-42 optionally include receiving a public key of a second relying party that is distinct from the public key of the first relying party; and generating a second shared secret value based on the private key and on the public key of the second relying party in response to a second OTP production request; and generating a second OTP sequence based on the second shared secret value in response to the second OTP production request, wherein the second OTP sequence is unique to the second relying party and to the second OTP production request.

Example 44 is at least one machine-readable medium comprising instructions that, when executed on a processor-based computing system, cause the computing system to execute the method according to any one of Examples 31-43.

Example 45 is a system for one-time password (OTP) transactions with a relying party, the system comprising means according to any one of Examples 31-43.

Example 46 is a machine-implemented method for one-time password (OTP) transactions with an authenticating party, the method being carried out by computing hardware of an OTP verifier device, the method comprising: generating a set of asymmetric cryptographic keys including a public key and a private key; sending a first OTP production request and the public key to the authenticating party; receiving a first OTP sequence from the authenticating party in response to the first OTP production request, the first OTP sequence being based on a first shared secret value, and being unique to the authenticating party and to the first OTP production request, wherein the first shared secret value is based on the public key and on a private key of the authenticating party; locally generating a verification copy of the first shared secret value based on the private key and on the public key of the authenticating party; locally generating a verification copy of the first OTP sequence based on the verification copy of the first shared secret value; comparing the first OTP sequence received in response to the first OTP production request against the verification copy of the first OTP sequence to produce a comparison result; and in response to the comparison result being a match, indicating successful verification of the first OTP sequence.

In Example 47, the subject matter of Example 46 optionally includes wherein generating the set of asymmetric cryptographic keys includes dynamically generating the asymmetric cryptographic keys in response to a call for processing of a transaction, such that the public key and the private key are unique to the transaction.

In Example 48, the subject matter of any one or more of Examples 46-47 optionally include wherein the asymmetric keys include an elliptic curve key pair.

In Example 49, the subject matter of any one or more of Examples 46-48 optionally include verifying authenticity of an issuer of a digital certificate that includes the public key of the authenticating party, and wherein the digital certificate is signed by the issuer of the digital certificate.

In Example 50, the subject matter of Example 49 optionally includes conducting a registration process wherein the digital certificate is received, and the public key of the authenticating party is extracted from the digital certificate and stored locally.

In Example 51, the subject matter of any one or more of Examples 46-50 optionally include producing a series of timestamps in a time window preceding a current time; and generating the estimates of the first OTP sequence based on at least a portion of the series of timestamps, wherein the verification copy of the first OTP sequence is one of the estimates.

In Example 52, the subject matter of Example 51 optionally includes wherein the verification copy of the first OTP sequence is based on a combination of at least the verification copy of the first shared secret value and a first timestamp from among the series of timestamps.

In Example 53, the subject matter of Example 52 optionally includes wherein the verification copy of the first OTP sequence is based on a cryptographic hash of the combination of at least the verification copy of the first shared secret value and the first timestamp.

In Example 54, the subject matter of Example 53 optionally includes wherein the verification copy of the first OTP sequence is based on a cryptographic hash of the combination of the verification copy of the first shared secret value, the first timestamp, and a sequence index number.

In Example 55, the subject matter of any one or more of Examples 51-54 optionally include wherein the verification copy of the first OTP sequence is a data-reduced value derived from the cryptographic hash of the combination of at least the verification copy of the first shared secret value and a timestamp value from among the series of timestamps.

Example 56 is at least one machine-readable medium comprising instructions that, when executed on a processor-based computing system, cause the computing system to execute the method according to any one of Examples 46-55.

Example 57 is a system for one-time password (OTP) transactions with an authenticating party, the system comprising means according to any one of Examples 46-55.

Example 58 is at least one machine-readable storage medium comprising instructions that, when executed on computing hardware of a one-time password presenter, cause the computing hardware to perform operations of: generating a set of asymmetric cryptographic keys including a public key and a private key; receiving a public key of a first relying party; generating a first shared secret value based on the private key and on the public key of the first relying party in response to a first OTP production request; and generating a first OTP sequence based on the first shared secret value in response to the first OTP production request, wherein the first OTP sequence is unique to the first relying party and to the first OTP production request.

In Example 59, the subject matter of Example 58 optionally includes wherein the asymmetric keys include an elliptic curve key pair.

In Example 60, the subject matter of any one or more of Examples 58-59 optionally include instructions for receiving, from a certificate authority, a digital certificate that includes the public key of the set of asymmetric keys, and wherein the digital certificate is signed by the certificate authority.

In Example 61, the subject matter of Example 60 optionally includes instructions for conducting a registration process wherein the digital certificate is provided to the relying party in advance of any OTP authentication transaction.

In Example 62, the subject matter of any one or more of Examples 58-61 optionally include instructions for producing a first timestamp based on a current time, and for generating the first OTP sequence based on the first timestamp.

In Example 63, the subject matter of Example 62 optionally includes wherein the first OTP sequence is based on a combination of at least the first shared secret value and the first timestamp.

In Example 64, the subject matter of Example 63 optionally includes wherein the first OTP sequence is based on a cryptographic hash of the combination of at least the first shared secret value and the first timestamp.

In Example 65, the subject matter of Example 64 optionally includes wherein the first OTP sequence is based on a cryptographic hash of a combination of the first shared secret value, the first timestamp, and a sequence index number.

In Example 66, the subject matter of any one or more of Examples 62-65 optionally include wherein the first OTP sequence is a data-reduced value derived from the cryptographic hash of the combination of at least the first shared secret value and the first timestamp.

In Example 67, the subject matter of any one or more of Examples 58-66 optionally include wherein the public key of the first relying party is ephemeral.

in Example 68, the subject matter of any one or more of Examples 58-67 optionally include wherein the OTP production request is originated by the first relying party.

In Example 69, the subject matter of any one or more of Examples 58-68 optionally include instructions for: receiving a public key of a second relying party that is distinct from the public key of the first relying party; and generating a second shared secret value based on the private key and on the public key of the second relying party in response to a second OTP production request; and generating a second OTP sequence based on the second shared secret value in response to the second OTP production request, wherein the second OTP sequence is unique to the second relying party and to the second OTP production request.

Example 70 is at least one machine-readable storage medium comprising instructions that, when executed on computing hardware of a one-time password verifier, cause the computing hardware to perform operations of: generating a set of asymmetric cryptographic keys including a public key and a private key; sending a first OTP production request and the public key to the authenticating party; receiving a first OTP sequence from the authenticating party in response to the first OTP production request, the first OTP sequence being based on a first shared secret value, and being unique to the authenticating party and to the first OTP production request, wherein the first shared secret value is based on the public key and on a private key of the authenticating party; locally generating a verification copy of the first shared secret value based on the private key and on the public key of the authenticating party; locally generating a verification copy of the first OTP sequence based on the verification copy of the first shared secret value; comparing the first OTP sequence received in response to the first OTP production request against the verification copy of the first OTP sequence to produce a comparison result; and in response to the comparison result being a match, indicating successful verification of the first OTP sequence.

In Example 71, the subject matter of Example 70 optionally includes wherein generating the set of asymmetric cryptographic keys includes dynamically generating the asymmetric cryptographic keys in response to a call for processing of a transaction, such that the public key and the private key are unique to the transaction.

In Example 72, the subject matter of any one or more of Examples 70-71 optionally include wherein the asymmetric keys include an elliptic curve key pair.

In Example 73, the subject matter of any one or more of Examples 70-72 optionally include instructions for verifying authenticity of an issuer of a digital certificate that includes the public key of the authenticating party, and wherein the digital certificate is signed by the issuer of the digital certificate.

In Example 74, the subject matter of Example 73 optionally includes instructions for conducting a registration process wherein the digital certificate is received, and the public key of the authenticating party is extracted from the digital certificate and stored locally on the at least one machine-readable storage medium.

In Example 75, the subject matter of any one or more of Examples 70-74 optionally include instructions for: producing a series of timestamps in a time window preceding a current time; and generating the estimates of the first OTP sequence based on at least a portion of the series of timestamps, wherein the verification copy of the first OTP sequence is one of the estimates.

In Example 76, the subject matter of Example 75 optionally includes wherein the verification copy of the first OTP sequence is based on a combination of at least the verification copy of the first shared secret value and a first timestamp from among the series of timestamps.

In Example 77, the subject matter of Example 76 optionally includes wherein the verification copy of the first OTP sequence is based on a cryptographic hash of the combination of at least the verification copy of the first shared secret value and the first timestamp.

In Example 78, the subject matter of Example 77 optionally includes wherein the verification copy of the first OTP sequence is based on a cryptographic hash of the combination of the verification copy of the first shared secret value, the first timestamp, and a sequence index number.

In Example 79, the subject matter of any one or more of Examples 75-78 optionally include wherein the verification copy of the first OTP sequence is a data-reduced value derived from the cryptographic hash of the combination of at least the verification copy of the first shared secret value and a timestamp value from among the series of timestamps.

Example 80 is a system for one-time password (OTP) transactions with a relying party, the system comprising: means for generating a set of asymmetric cryptographic keys including a public key and a private key; means for receiving a public key of a first relying party; means for generating a first shared secret value based on the private key and on the public key of the first relying party in response to a first OTP production request; and means for generating a first OTP sequence based on the first shared secret value in response to the first OTP production request, wherein the first OTP sequence is unique to the first relying party and to the first OTP production request.

In Example 81, the subject matter of Example 80 optionally includes wherein the asymmetric keys include an elliptic curve key pair.

In Example 82, the subject matter of any one or more of Examples 80-81 optionally include means for receiving, from a certificate authority, a digital certificate that includes the public key of the set of asymmetric keys, and wherein the digital certificate is signed by the certificate authority.

In Example 83, the subject matter of any one or more of Examples 80-82 optionally include means for conducting a registration process wherein the digital certificate is provided to the relying party in advance of any OTP authentication transaction.

In Example 84, the subject matter of any one or more of Examples 80-83 optionally include means for producing a first timestamp based on a current time; and means for generating the first OTP sequence based on the first timestamp.

In Example 85, the subject matter of Example 84 optionally includes wherein producing the first timestamp is performed locally.

In Example 86, the subject matter of any one or more of Examples 84-85 optionally include wherein the first OTP sequence is based on a combination of at least the first shared secret value and the first timestamp.

In Example 87, the subject matter of Example 86 optionally includes Wherein the first OTP sequence is based on a cryptographic hash of the combination of at least the first shared secret value and the first timestamp.

In Example 88, the subject matter of Example 87 optionally includes wherein the first OTP sequence is based on a cryptographic hash of a combination of the first shared secret value, the first timestamp, and a sequence index number.

In Example 89, the subject matter of any one or more of Examples 84-88 optionally include wherein the first OTP sequence is a data-reduced value derived from the cryptographic hash of the combination of at least the first shared secret value and the first timestamp.

In Example 90, the subject matter of any one or more of Examples 80-89 optionally include wherein the public key of the first relying party is ephemeral.

In Example 91, the subject matter of any one or more of Examples 80-90 optionally include wherein the OTP production request is originated by the first relying party.

In Example 92, the subject matter of any one or more of Examples 80-91 optionally include means for receiving a public key of a second relying party that is distinct from the public key of the first relying party; and means for generating a second shared secret value based on the private key and on the public key of the second relying party in response to a second OTP production request; and means for generate a second OTP sequence based on the second shared secret value in response to the second OTP production request, wherein the second OTP sequence is unique to the second relying party and to the second OTP production request.

Example 93 is a system for one-time password (OTP) transactions with an authenticating party, the system comprising: means for generating a set of asymmetric cryptographic keys including a public key and a private key; means for sending a first OTP production request and the public key to the authenticating party; means for receiving a first OTP sequence from the authenticating party in response to the first OTP production request, the first OTP sequence being based on a first shared secret value, and being unique to the authenticating party and to the first OTP production request, wherein the first shared secret value is based on the public key and on a private key of the authenticating party; means for locally generating a verification copy of the first shared secret value based on the private key and on the public key of the authenticating party; means for locally generating a verification copy of the first OTP sequence based on the verification copy of the first shared secret value; means for comparing the first OTP sequence received in response to the first OTP production request against the verification copy of the first OTP sequence to produce a comparison result; and means for indicating successful verification of the first OTP sequence in response to the comparison result being a match.

In Example 94, the subject matter of Example 93 optionally includes wherein the means for generating the set of asymmetric cryptographic keys include means for dynamically generating the asymmetric cryptographic keys in response to a call for processing of a transaction, such that the public key and the private key are unique to the transaction.

In Example 95, the subject matter of any one or more of Examples 93-94 optionally include wherein the asymmetric keys include an elliptic curve key pair.

In Example 96, the subject matter of any one or more of Examples 93-95 optionally include means for verifying authenticity of an issuer of a digital certificate that includes the public key of the authenticating party, and wherein the digital certificate is signed by the issuer of the digital certificate.

In Example 97, the subject matter of any one or more of Examples 93-96 optionally include means for conducting a registration process wherein the digital certificate is received, and the public key of the authenticating party is extracted from the digital certificate and stored locally on the system.

In Example 98, the subject matter of any one or more of Examples 93-97 optionally include means for producing a series of timestamps in a time window preceding a current time; and means for generating the estimates of the first OTP sequence based on at least a portion of the series of timestamps, wherein the verification copy of the first OTP sequence is one of the estimates.

In Example 99, the subject matter of Example 98 optionally includes wherein the verification copy of the first OTP sequence is based on a combination of at least the verification copy of the first shared secret value and a first timestamp from among the series of timestamps.

In Example 100, the subject matter of Example 99 optionally includes wherein the verification copy of the first OTP sequence is based on a cryptographic hash of the combination of at least the verification copy of the first shared secret value and the first timestamp.

In Example 101, the subject matter of Example 100 optionally includes wherein the verification copy of the first OTP sequence is based on a cryptographic hash of the combination of the verification copy of the first shared secret value, the first timestamp, and a sequence index number.

In Example 102, the subject matter of any one or more of Examples 98-101 optionally include wherein the verification copy of the first OTP sequence is a data-reduced value derived from the cryptographic hash of the combination of at least the verification copy of the first shared secret value and a timestamp value from among the series of timestamps.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An apparatus for one-time password (OTP) transactions with a relying party, the apparatus comprising:
a key pair manager to access a set of asymmetric cryptographic keys including a public key and a private key;
a relying party interface to receive a public key of a first relying party;
a shared secret generator to generate a first shared secret value based on the private key and on the public key of the first relying party in response to a first OTP production request; and
an OTP sequence generator to generate a first OTP sequence based on the first shared secret value in response to the first OTP production request, wherein the first OTP sequence is unique to the first relying party and to the first OTP production request.

2. The apparatus of claim 1, further comprising:
a certificate authority interface to receive, from a certificate authority, a digital certificate that includes the public key of the set of asymmetric keys, and wherein the digital certificate is signed by the certificate authority.

3. The apparatus of claim 1, further comprising:
a timekeeping engine to produce a first timestamp based on a current time; and
wherein the OTP sequence generator is to generate the first OTP sequence based on the first timestamp.

4. The apparatus of claim 3, wherein the first OTP sequence is based on a combination of at least the first shared secret value and the first timestamp.

5. The apparatus of claim 4, wherein the first OTP sequence is based on a cryptographic hash of the combination of at least the first shared secret value and the first timestamp.

6. The apparatus of claim 5, wherein the first OTP sequence is based on a cryptographic hash of a combination of the first shared secret value, the first timestamp, and a sequence index number.

7. The apparatus of claim 3, wherein the first OTP sequence is a data-reduced value derived from the cryptographic hash of the combination of at least the first shared secret value and the first timestamp.

8. The apparatus of claim 1, wherein the OTP production request is originated by the first relying party.

9. The apparatus of claim 1, wherein the relying party interface is to receive a public key of a second relying party that is distinct from the public key of the first relying party; and
wherein the shared secret generator is to generate a second shared secret value based on the private key and on the public key of the second relying party in response to a second OTP production request; and
wherein the OTP sequence generator is to generate a second OTP sequence based on the second shared secret value in response to the second OTP production request, wherein the second OTP sequence is unique to the second relying party and to the second OTP production request.

10. A machine-implemented method for one-time password (OTP) transactions with an authenticating party, the method being carried out by computing hardware of an OTP verifier device, the method comprising:
generating a set of asymmetric cryptographic keys including a public key and a private key;
sending a first OTP production request and the public key to the authenticating party;
receiving a first OTP sequence from the authenticating party in response to the first OTP production request, the first OTP sequence being based on a first shared secret value, and being unique to the authenticating party and to the first OTP production request, wherein the first shared secret value is based on the public key and on a private key of the authenticating party;
locally generating a verification copy of the first shared secret value based on the private key and on the public key of the authenticating party;
locally generating a verification copy of the first OTP sequence based on the verification copy of the first shared secret value;
comparing the first OTP sequence received in response to the first OTP production request against the verification copy of the first OTP sequence to produce a comparison result; and
in response to the comparison result being a match, indicating successful verification of the first OTP sequence.

11. The method of claim 10, wherein generating the set of asymmetric cryptographic keys includes dynamically generating the asymmetric cryptographic keys in response to a call for processing of a transaction, such that the public key and the private key are unique to the transaction.

12. The method of claim 10, further comprising:
verifying authenticity of an issuer of a digital certificate that includes the public key of the authenticating party, and wherein the digital certificate is signed by the issuer of the digital certificate.

13. The method of claim 12, further comprising:
conducting a registration process wherein the digital certificate is received, and the public key of the authenticating party is extracted from the digital certificate and stored locally.

14. The method of claim 10, further comprising:
producing a series of timestamps in a time window preceding a current time; and
generating the estimates of the first OTP sequence based on at least a portion of the series of timestamps, wherein the verification copy of the first OTP sequence is one of the estimates.

15. The method of claim 14, wherein the verification copy of the first OTP sequence is based on a combination of at least the verification copy of the first shared secret value and a first timestamp from among the series of timestamps.

16. At least one machine-readable storage medium comprising instructions that, when executed on computing hardware of a one-time password presenter, cause the computing hardware to perform operations of:
generating a set of asymmetric cryptographic keys including a public key and a private key;
receiving a public key of a first relying party;
generating a first shared secret value based on the private key and on the public key of the first relying party in response to a first OTP production request; and
generating a first OTP sequence based on the first shared secret value in response to the first OTP production request, wherein the first OTP sequence is unique to the first relying party and to the first OTP production request.

17. The at least one machine-readable storage medium of claim 16, further comprising instructions for receiving, from a certificate authority, a digital certificate that includes the public key of the set of asymmetric keys, and wherein the digital certificate is signed by the certificate authority.

18. The at least one machine-readable storage medium of claim 16, further comprising instructions for producing a first timestamp based on a current time, and for generating the first OTP sequence based on the first timestamp.

19. The at least one machine-readable storage medium of claim 18, wherein the first OTP sequence is based on a combination of at least the first shared secret value and the first timestamp.

20. The at least one machine-readable storage medium of claim 19, wherein the first OTP sequence is based on a cryptographic hash of the combination of at least the first shared secret value and the first timestamp.

21. The at least one machine-readable storage medium of claim 20, wherein the first OTP sequence is based on a cryptographic hash of a combination of the first shared secret value, the first timestamp, and a sequence index number.

22. The at least one machine-readable storage medium of claim 18, wherein the first OTP sequence is a data-reduced value derived from the cryptographic hash of the combination of at least the first shared secret value and the first timestamp.

23. The at least one machine-readable storage medium of claim 16, wherein the public key of the first relying party is ephemeral.

24. The at least one machine-readable storage medium of claim 16, wherein the OTP production request is originated by the first relying party.

25. The at least one machine-readable storage medium of claim 16, further comprising instructions for:
receiving a public key of a second relying party that is distinct from the public key of the first relying party; and
generating a second shared secret value based on the private key and on the public key of the second relying party in response to a second OTP production request; and
generating a second OTP sequence based on the second shared secret value in response to the second OTP production request, wherein the second OTP sequence is unique to the second relying party and to the second OTP production request.
